(19) United States
(12) Patent Application Publication
(10) Pub. No.: US 2025/0106233 A1
(43) Pub. Date: Mar. 27, 2025

(54) System and method for identifying anomalous network sessions in a network environment

(71) Applicant: Bank of America Corporation, Charlotte, NC (US)

(72) Inventors: Jack L. Bishop, III, Evanston, IL (US); Ryan Francis Muzzo, Saint Charles, IL (US); Jason Conrad Starin, Huntersville, NC (US)

(21) Appl. No.: 18/475,504

(22) Filed: Sep. 27, 2023

(51) Int. Cl. H04L 9/40; G06F 18/2321

(52) U.S. Cl. CPC H04L 63/1425; G06F 18/2321

(57) ABSTRACT

A system for identifying one or more anomalous network sessions in a network environment includes a memory and a processor coupled to the memory. The processor collects network traffic data based on a plurality of network sessions between a source and a destination in the network environment. The processor parses the network traffic data to identify a plurality of parameters associated with the network traffic data at different network layers. The processor clusters the network traffic data into baseline network traffic data based on one or more specific parameters of the plurality of parameters. The processor identifies unknown network traffic based upon the clustered network traffic data and analyzes the unknown network traffic with respect to the baseline network traffic data to identify the one or more anomalous network sessions. The processor determines and performs one or more mitigation actions for the identified one or more anomalous network sessions.

### TECHNICAL FIELD

The present disclosure relates generally to network communication, and more specifically to a system and method for identifying anomalous network sessions in a network environment.

### BACKGROUND

In a network environment, various types of data may be exchanged between network devices. A plurality of network sessions may exist between these network devices to exchange the data. A network intruder or a bad actor may gain unauthorized access to one or more of these existing network sessions or may form one or more anomalous network sessions on their own to exfiltrate and/or infiltrate anomalous data into the network. Present technologies fail to identify in real time such bad actors and potentially anomalous network sessions among the plurality of network sessions in the network environment. Generally, with the present technologies, if an anomalous network session is identified in the network, the entire network (including the plurality of network sessions) needs to be taken down to counteract that identified anomalous network session.

### SUMMARY

The system and method implemented by the system as disclosed in the present disclosure provide technical solutions to the technical problems discussed above by identifying one or more anomalous network sessions among a plurality of network sessions in a network environment and performing mitigation actions for the identified sessions without disrupting other sessions. The disclosed system and method provide several practical applications and technical advantages. For example, the disclosed system may be installed into an inspection area of a network layer to identify, in real time, one or more anomalous sessions in a plurality of network sessions between a source (e.g., an endpoint device) and a destination (e.g., a cloud service provider, a third party, etc.) in the network environment. If there is some malicious or anomalous activity identified in a network traffic flow, then instead of disrupting all the network sessions, the disclosed system is configured to perform mitigation actions for only those network sessions that are identified to be anomalous.

To identify anomalous network sessions in a network environment, a data collector of the disclosed system may first collect network traffic data that may be flowing between the source and the destination. This could be either between an endpoint device and a cloud service provider or a demilitarized zone (DMZ) and a cloud service provider. Then metadata is obtained from this collected network traffic data.

Metadata may include, for example, a source IP address, a destination IP address, payload size, socket information, port information including source port and destination port, header information, etc. A data typification component of the disclosed system may parse the collected network traffic data and/or the obtained metadata to identify a plurality of parameters at different network layers. For example, in one embodiment, the data typification process is performed to identify Open Systems Interconnection Model (OSI) layer 1-5 header information. In another embodiment, the data typification process is performed to identify information from the TCP/IP model. The parsed network traffic data is stored in a first data store. A data extraction component of the disclosed system may extract a subset of network traffic data using the parsed network traffic data stored in the first data store. The extracted subset of network traffic data is relevant for the identification of anomalous network sessions. A hierarchical clustering component of the disclosed system may perform clustering based on the extracted subset of network traffic data to identify a cluster of normal or baseline network traffic data and unknown network traffic. For example, the clustering results in a centroid of normal network traffic data with similar network traffic clustered together with some data points farther away from this centroid. These data points which are farther away are the outliers and may potentially represent anomalous network sessions. A cluster analysis component of the disclosed system may perform cluster analysis on the clustered network traffic data to identify one or more anomalous network sessions among the plurality of network sessions in the network environment. The clustering may be performed using a particular clustering technique, such as, for example, K-means clustering or Calinski-Harabasz criterion clustering. In one embodiment, the cluster analysis may include analyzing the unknown network traffic with respect to the baseline network traffic data to determine whether or not the unknown network traffic is actually anomalous. In one embodiment, the cluster analysis may be performed using a machine learning or an artificial intelligence technique. Once an anomalous network session is identified based on this cluster analysis, a prohibition analysis component of the disclosed system may determine a particular mitigation action and recommend a mitigation action for the identified anomalous network session. The mitigation action may include, for example and without limitation, terminating the identified anomalous network session, slowing down network traffic across the identified anomalous network session, requesting user(s) associated with the identified anomalous network session to re-authenticate, adding the identified anomalous network session to a disapproved list or a denial of service list, re-routing the identified anomalous network session to a particular location (e.g., a honeypot), locking user accounts of the user(s) associated with the identified anomalous network session, etc.

In one embodiment, the disclosed system for identifying one or more anomalous network sessions in a network environment includes a memory comprising a first data store and a second data store. The first data store is operable to store network traffic data (e.g., metadata) and the second data store is operable to store clustered network traffic data (e.g., metadata). The disclosed system further includes a processor that is operably coupled to the memory, and configured to collect network traffic data based at least in part on a plurality of network sessions between a source and a destination in the network environment. The processor is then configured to parse the network traffic data to identify a plurality of parameters associated with the network traffic data at different network layers. The processor is then configured to cluster the network traffic data into baseline network traffic data based on one or more specific parameters of the plurality of parameters associated with the network traffic data at one or more network layers. The processor is then configured to identify unknown network traffic based at least in part upon the clustered network traffic data. The processor is then configured to analyze the unknown network traffic with respect to the baseline network traffic data to identify the one or more anomalous network sessions in the plurality of network sessions. The processor is then configured to determine one or more mitigation actions for the identified one or more anomalous network sessions and perform the one or more mitigation actions.

The disclosed system and the method implemented by the system as disclosed in the present disclosure improves overall network utilization by saving network resources (e.g., by not disrupting entire network and re-initiating the entire network just because of one or more anomalous network sessions in the network) and addresses security concerns without disrupting non-affected network participants. Thus, the disclosed system and the method improves data security in the network environment. If there are bad actors involved in any part of the network communication, then those bad actors may be identified in real time and their associated network sessions may be severed before they impact the overall network. Certain embodiments of the present disclosure may include some, all, or none of these practical applications and technical advantages discussed herein. These practical applications, technical advantages, and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example system for identifying one or more anomalous network sessions in a network environment, in accordance with particular embodiments of the present disclosure; and

FIGS. 2A-2C illustrate a flowchart of an example method for identifying one or more anomalous network sessions in a network environment, in accordance with one or more embodiments of the present disclosure.

### DETAILED DESCRIPTION

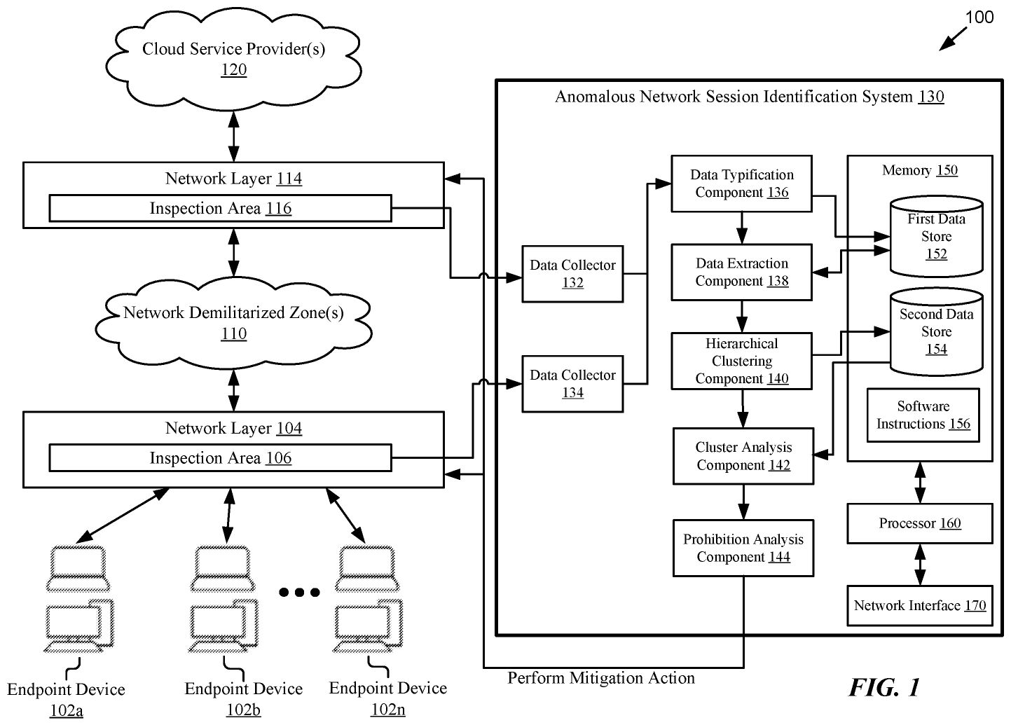

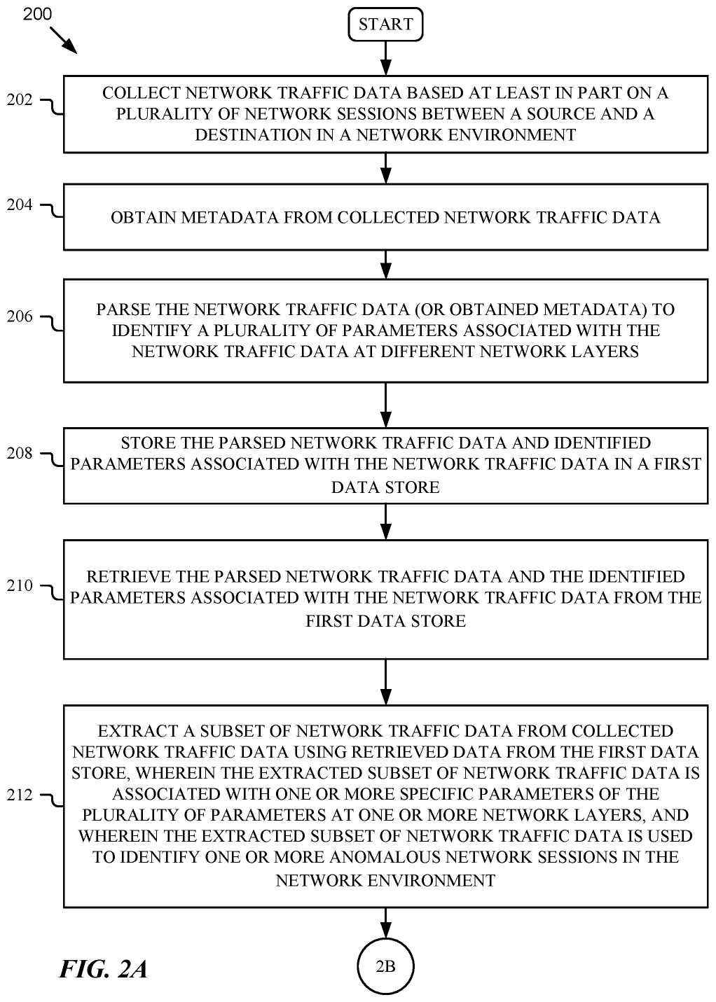

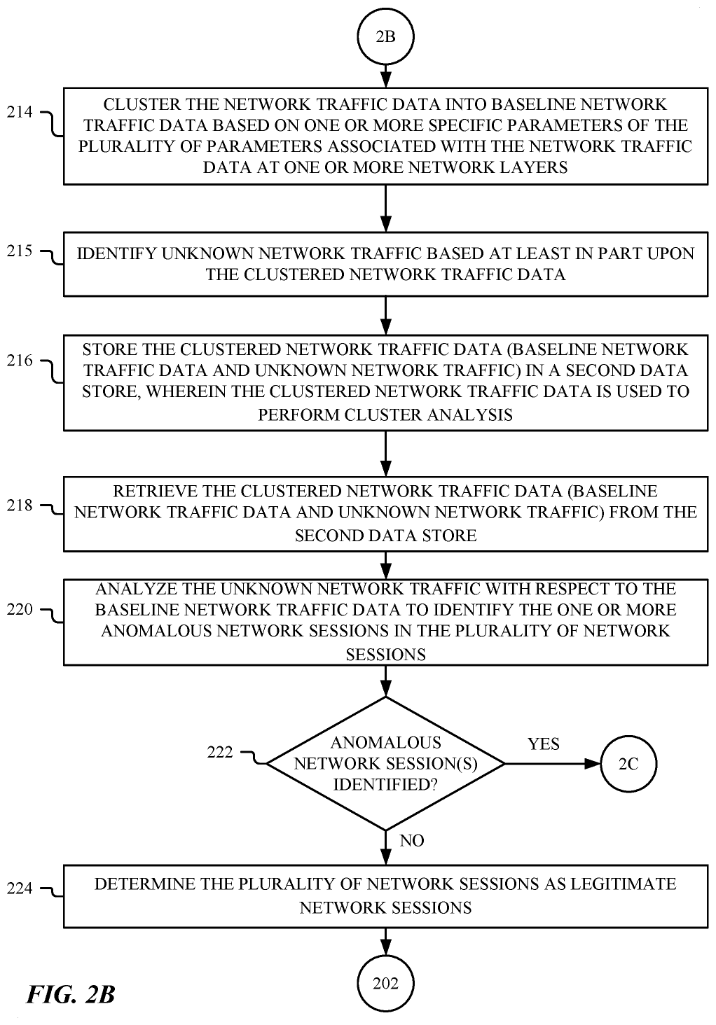

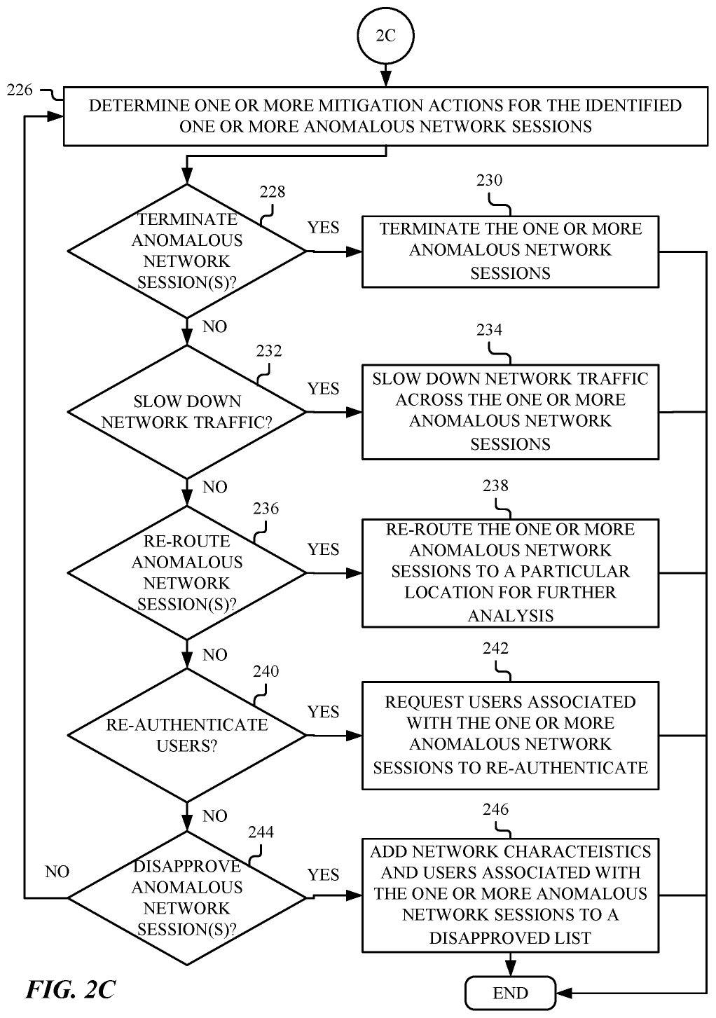

As described above, there may be bad actors infiltrating or exfiltrating data into a network. Present technologies fail to identify these bad actors and potentially malicious or anomalous network sessions among a plurality of network sessions in a network environment. If an anomalous network session or activity is identified in the network, with the present technologies, the entire network has to be taken down to counteract that identified anomalous network session. FIG. 1 illustrates an example system 100 and FIGS. 2A-2C illustrate an example method 200 for identifying one or more anomalous network sessions among a plurality of network sessions in a network environment and performing one or more mitigation actions for the identified network sessions without disrupting other network sessions in the plurality of network sessions. Each of the system and the method is discussed in detail below.

### Example System

FIG. 1 is a schematic diagram of an example system 100 for identifying one or more anomalous network sessions in a network environment, in accordance with particular embodiments of the present disclosure. As depicted, the system 100 may include a plurality of endpoint devices 102a, 102b, . . . , 102n (individually and/or collectively herein referred to as 102), one or more network demilitarized zones (DMZs) 110, one or more cloud service providers 120, a network layer 104 comprising an inspection area 106, a network layer 114 comprising an inspection area 116, and an anomalous network session identification system 130.

At a high level, an endpoint device 102 may communicate with a cloud service provider 120 via a DMZ 110. For instance, the endpoint device 102 may send data or retrieve data from the cloud server provider 120. A plurality of network sessions may be generated between the endpoint device 102 and the DMZ 110 and between the DMZ 110 and the cloud server provider 120 in order to send or retrieve this data between the devices. The data between the two devices may pass through a network layer 104 or 114. For instance, the data between the endpoint device 102 and the DMZ 110 may pass through the network layer 104 and the data between the DMZ 110 and the cloud service provider 120 may pass through the network layer 114. As discussed elsewhere herein, a bad actor or network intruder may introduce anomalous or malicious data into one or more of the network sessions between the two devices (e.g., endpoint device 102 and DMZ 110 or DMZ 110 and cloud service provider 120). The anomalous network session identification system 130 may be installed into an inspection area of a network to identify one or more anomalous sessions in the plurality of network sessions between a source (e.g., endpoint device 102) and a destination (e.g., cloud service provider 120) in the network environment. In one embodiment, the anomalous network session identification system 130 may be installed into the inspection area 106 of the network layer 104 to identify one or more anomalous sessions in a plurality of network sessions between the endpoint device 102 and the cloud service provider 120. In another embodiment, the anomalous network session identification system 130 may be installed into the inspection area 116 of the network layer 114 to identify one or more anomalous sessions in a plurality of network sessions between the DMZ 110 and the cloud service provider 120. Each of the network devices, including the endpoint devices 102, the DMZ 110, and the cloud service provider 120, and various operations associated with the anomalous network session identification system 130 is now individually discussed in detail below.

### Endpoint devices

Endpoint devices 102a-102n may be devices associated with an entity to generate and process various types of data. In one example embodiment, the entity may be a financial institution (e.g., a bank), the data may be financial data, and the endpoint devices 102 may be various types of devices associated with different users of the financial institution. Examples of endpoint devices 102 may include, but are not limited to, computers, laptops, desktops, mobile devices (e.g., smart phones or tablets), servers, clients, virtual machines, or any other suitable type of network device. Users associated with these endpoint devices 102 may include, for example and without limitation, customers, employees, or contractors associated with a particular entity, such as a financial institution or bank.

The data that is generated and processed at an endpoint device may be sent to a cloud service provider 120 for storage. Alternatively, data from the cloud service provider 120 may be retrieved and downloaded on the endpoint device 102. As discussed earlier, the data that is exchanged between an endpoint device 102 and a cloud service provider 120 passes through one or more DMZs 110 and network layers 104 and 114 before reaching to their respective destination.

### Network Demilitarized Zones

In particular embodiments, one or more DMZs 110 may exist between an endpoint device 102 and a cloud service provider 120. A DMZ is an intermediary network is a transit network between an external network associated with the cloud service provider 120 and an internal network associated with the endpoint device 102. The DMZ may deploy security protocols to support secure communication and exchange of information between the endpoint device 102 and the cloud service provider 120. The end goal of a DMZ network is to enable an endpoint device 102 to access untrusted networks, such as the Internet, while ensuring its private network or local area network (LAN) remains secure. As discussed earlier, when an endpoint device 102 sends data to or retrieves data from a cloud service provider 120, the data is passed through an appropriate DMZ 110 via a network layer 104 or 114. For example, when the endpoint device 102 sends data to the cloud service provider 120 for storage, the data is first sent to the DMZ 110 via the network layer 104 and then the data is sent from the DMZ to the cloud service provider 120 via the network layer 114.

### Cloud Service Providers

Cloud service providers 120 may be devices located at a cloud or an external network location to store and provide access to various types of data stored therein. In one embodiment, the data may be received from endpoint devices 102 and stored in one or more cloud service providers 120. Examples of cloud service providers 120 may include, but are not limited to, cloud servers, cloud computers, remote clients, remote computers, or any other suitable type of remote network device.

### Network Layers and Inspection Areas

Network layer 104 or 114 may be any suitable type of network layer for sending data between two network devices (e.g., endpoint device 102 and DMZ 110 or DMZ 110 and cloud service provider 120). The network layer 104 or 114 may include wireless and/or wired network, including, but not limited to, all or a portion of the Internet (e.g., including without limitation internet peers, trusted third parties, etc.), an Intranet, a private network, a public network, a peer-to-peer network, the public switched telephone network, a cellular network, a local area network (LAN), a metropolitan area network (MAN), a wide area network (WAN), and a satellite network. The network layer 104 or 114 may be configured to support any suitable type of communication protocol as would be appreciated by one of ordinary skill in the art.

In particular embodiments, a plurality of network sessions may be initiated between two network devices over which data is exchanged via the network layer 104 or 114. As discussed elsewhere herein, a network intruder may hijack one or more of the plurality of network sessions and try to exfiltrate or infiltrate anomalous data into the network causing the hijacked network sessions as anomalous network sessions. As depicted, the network layers 104 and 114 respectively include inspection areas 106 and 116 into which the anomalous network session identification system 130 may be installed to support data capture and perform one or more mitigation actions against identified anomalous network sessions.

### Anomalous Network Session Identification System

The anomalous network session identification system 130 is configured to identify one or more anomalous network sessions among a plurality of network sessions in a network environment and perform one or more mitigation actions for the identified network sessions. If there is some malicious or anomalous activity identified in a network traffic flow, then instead of disrupting all the network sessions, the anomalous network session identification system 130 is configured to perform mitigation actions for only those network sessions that are identified to be anomalous. The anomalous network session identification system 130 provides various practical applications and advantages over existing network systems. By way of an example and without limitation, the anomalous network session identification system 130 may (1) improve overall network utilization by saving and not unnecessarily wasting network resources (e.g., by not disrupting entire network and re-initiating the entire network just because of one or more anomalous network sessions in the network), (2) support secure communication and exchange of data between various network devices, and (3) identify bad actors and their associated anomalous network session(s) in real time and sever these session(s) before they impact the overall network.

The anomalous network session identification system 130 may reside at the inspection area 106 of the network layer 104 to identify one or more anomalous network sessions in a plurality of network sessions between an endpoint device 102 and a DMZ 110. Similarly, the data collector 132/134 may reside at the inspection area 106/116 to capture session data in a plurality of network sessions between a cloud service provider 120 and a DMZ 110. The anomalous network session identification system 130 includes a set of components to perform its functionality discussed herein. As depicted, these components include, for example, data collector 132 (when system 130 resides in inspection area 106) or data collector 134 (when system 130 resides in inspection area 116), a data typification component 136, a data extraction component 138, a hierarchical clustering component 140, a cluster analysis component 142, and a prohibition analysis component 144. These components 132-144 may be communicatively coupled with each other to share their respective data. Also, one or more of these components 132-144 may store their respective data in a memory 150 of the anomalous network session identification system 130. Furthermore, the components 132-144 may be implemented by a processor 160 that is coupled to the memory 150. Each of these components 132-144 is discussed below.

The data collector 132 (or 134) is configured to collect network traffic data based at least in part on a plurality of network sessions between a source device and a destination device in a network environment. For instance, the data collector 132 collects all of the network traffic data that is flowing over the plurality of network sessions between an endpoint device 102 and a DMZ 110. Likewise, the data collector 134 collects all of the network traffic data that is flowing over the plurality of network sessions between a cloud service provider 120 and a DMZ 110. The data collector 132 (or 134) is further configured to obtain metadata from the collected network traffic data. The metadata may include, for example and without limitation, a source IP address, a destination IP address, payload size, socket information, port information including source port and destination port, header information, request frequency, etc. The data collector 132 (or 134) may send its collected network traffic data and/or obtained metadata from the collected network traffic data to the data typification component 136 to perform its respective operation thereon.

The data typification component 136 is configured to parse the network traffic data and/or the metadata obtained from the network traffic data collected by the data collector 132 or 134. Typification or parsing is done to identify a plurality of parameters associated with the metadata of the network traffic data at different network layers. The different network layers may include, for example, different abstraction layers of open system interconnection (OSI) model including physical layer, data link layer, network layer, transport layer, session layer, presentation layer, and application layer. In one embodiment, the data typification component 136 performs its parsing based on deep packet inspection and header analysis, which results in a classification hierarchy of what traffic flows looks like at the different network layers. As an example, the data typification or parsing is performed to identify header information at different OSI layers. For instance, the data typification component 136 may parse the obtained metadata from the collected network traffic data to identify OSI layer 1-5 header information. The data typification component 136 may store the parsed network traffic data and identified parameters associated with the network traffic data at different network layers in a first data store 152 of the memory 150 for later access and/or retrieval.

The data extraction component 138 is configured to extract a subset of network traffic data from the collected network traffic data. The extraction is done to narrow the collected network traffic data to a relevant subset and generally contains data suitable for identifying anomalous network sessions or activities. In one embodiment, the data extraction component 138 may perform this extraction by retrieving the parsed network traffic data and the identified parameters associated with the network traffic data at the different network layers from the first data store 152 and then extracting the subset of network traffic data using the retrieved data from the first data store 152. The extracted subset of network traffic data may be associated with one or more specific parameters at one or more network layers. For example, the extracted subset of network traffic data may include only layer 5 header information. As another example, the extracted subset of network traffic may include potential network paths that are known to identify anomalous network sessions or activities.

The hierarchical clustering component 140 is configured to cluster network traffic data into clusters that may identify unknown network traffic based at least in part upon the clustered network traffic data. The hierarchical clustering component 140 may perform the clustering discussed herein using a particular clustering technique, such as, for example and without limitation, K-means clustering or Calinski-Harabasz criterion clustering. The hierarchical clustering component 140 may perform the clustering based on the one or more specific parameters (e.g., potential network paths, layer 5 header information) associated with the subset of network traffic data. In one embodiment, the hierarchical clustering component may perform its clustering by comparing the subset of network traffic data against one or more predetermined thresholds and generating a cluster of the baseline network traffic data and the unknown network traffic. Stated differently, the clustering may result in a centroid of baseline network traffic data with similar network traffic clustered together. There may be some data points which are farther away from this centroid. These data points which are farther away from the centroid are the unknown or the unknown network traffic, which may potentially represent anomalous network sessions. Responsive to clustering, the hierarchical clustering component 140 may store the clustered network traffic data, including the baseline network traffic data and the unknown network traffic, in a second data store 154 of the memory 150 for later access and/or retrieval.

The cluster analysis component 142 is configured to analyze unknown network traffic resulted from the clustering with respect to the baseline network traffic data to identify one or more anomalous network sessions in the plurality of network sessions. If one or more anomalous network sessions are identified, then the unknown network traffic can be considered outlier network traffic. In one embodiment, the cluster analysis component 142 may perform its analysis by retrieving the clustered network traffic data, including the baseline network traffic data and unknown network traffic, from the second data store 154 and then performing cluster analysis using the clustered network traffic data retrieved from the second data store 154. In one embodiment, the cluster analysis may include analyzing or investigating unknown network traffic with respect to the baseline network traffic data to determine whether or not the unknown network traffic is actually anomalous and identifying one or more anomalous network sessions in the plurality of network sessions responsive to determining that the unknown network traffic is actually anomalous. One non-limiting example of cluster analysis may include comparing real-time network paths that are known to contain anomalous or malicious network activity against the clustered network data retrieved from the second data store 154 to identify one or more anomalous network sessions. If in case, the cluster analysis component 142 determines, based on its operation, that the unknown network traffic is not anomalous, then the cluster analysis component 142 may determine the plurality of network sessions between the two network devices as legitimate network sessions.

The prohibition analysis component 144 is configured to determine what mitigation actions to perform for the identified one or more anomalous network sessions. Once one or more mitigations actions are determined, the prohibition analysis component 144 is further configured to perform the one or more mitigation actions for the identified anomalous network sessions. The prohibition analysis component 144 performs these mitigation actions for the identified anomalous network sessions without disrupting other network sessions in the plurality of network sessions in the network environment. For example, if there are a total of 10 network sessions that exists between an endpoint 102 and a DMZ 110 and 2 of these network sessions are identified to be anomalous network sessions, then only these 2 anomalous network sessions are severed from the network environment and the remaining 8 network sessions are continued to exist. Examples of mitigation actions that may be performed for the identified anomalous network sessions include, but not limited to, terminating the anomalous network sessions, slowing down network traffic across the anomalous network sessions, re-routing the re anomalous network sessions to a particular location (e.g., a honeypot), restarting network sessions affected by the anomalous network sessions, requesting users associated with the anomalous network sessions to re-authenticate, locking user accounts of the users associated with the anomalous network sessions, adding network characteristics and the users associated with the anomalous network sessions to a disapproved list or a denial of service list, etc.

In some embodiments, one or more of the above-discussed components 136-144 may be performed using a machine learning (ML) or artificial intelligence (AI) technique. For instance, a ML model may be trained using network traffic data collected over a certain time period (e.g., days, weeks, months, etc.) and ground-truth data provided by a network expert (e.g., user who already evaluated the collected network traffic data and provided true results) to perform operations associated with the data typification component 136, the data extraction component 138, the hierarchical clustering component 140, the cluster analysis component 142, and the prohibition analysis component 144.

Each of the above-discussed components 132-144 is implementable or executable by the processor 160. Processor 160 comprises one or more processors operably coupled to the memory 150. The processor 160 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor 160 may be a programmable logic device, a microcontroller, a microprocessor, or any suitable combination of the preceding. The processor 160 is communicatively coupled to and in signal communication with a network interface 170 and the memory 150. The processor 160 is configured to process data. For example, the processor 160 may be 8-bit, 16-bit, 32-bit, 64-bit or of any other suitable architecture. The processor 160 may include an arithmetic logic unit (ALU) for performing arithmetic and logic operations, processor registers that supply operands to the ALU and store the results of ALU operations, and a control unit that fetches software instructions 156 from the memory 150 and executes them by directing the coordinated operations of the ALU, registers and other components. The processor 160 is configured to implement various software instructions 156. For example, the processor 160 is configured to execute the software instructions 156 to implement the functions disclosed herein, such as some or all of those described with respect to components 132-144. In some embodiments, the function described herein is implemented using logic units, FPGAs, ASICs, DSPs, or any other suitable hardware or electronic circuitry.

Memory 150 may be volatile or non-volatile and may comprise a read-only memory (ROM), random-access memory (RAM), ternary content-addressable memory (TCAM), dynamic random-access memory (DRAM), and static random-access memory (SRAM). Memory 150 may be implemented using one or more disks, tape drives, solid-state drives, and/or the like. As depicted, the memory 150 comprises the first data store 152 that is operable to store network traffic data, the second data store 154 that is operable to store clustered network traffic data, and/or any other data or software instructions 156. The software instructions 156 may comprise any suitable set of instructions, logic, rules, or code operable to execute the processor 160.

The network interface 170 is configured to enable wired and/or wireless communications. The network interface 170 is configured to communicate data between the anomalous network session identification system 130 and other devices, systems, or domains (e.g., network layers 104 and 114, endpoint devices 102, DMZ 110, and cloud service provider 120). For example, the network interface 170 may comprise a Wi-Fi interface, a LAN interface, a WAN interface, a modem, a switch, or a router. The processor 160 is configured to send and receive data using the network interface 170. The network interface 170 may be configured to use any suitable type of communication protocol as would be appreciated by one of ordinary skill in the art.

### Example Method

FIGS. 2A-2C illustrate a flowchart of an example method 200 for identifying one or more anomalous network sessions in a network environment. Modifications, additions, or omissions may be made to method 200. Method 200 may include more, fewer, or other steps. For example, operations may be performed in parallel or in any other suitable order. While at times discussed as the system 100, the anomalous network session identification system 130, processor 160, or components of any of thereof performing steps, any suitable system or components of the system may perform one or more steps of the method 200. For example, one or more steps of method 200 may be implemented, at least in part, in the form of software instructions (e.g., software instructions 156 of FIG. 1), stored on non-transitory, tangible, machine-readable media (e.g., memory 150 of FIG. 1) that when run by one or more processors (e.g., processor 160 of FIG. 1) may cause the one or more processors to perform steps 202-246.

Now referring to FIG. 2A, after start, the processor 160 of the anomalous network session identification system 130, at operation 202, collects network traffic data based at least in part on a plurality of network sessions between a source and a destination in a network environment. In one embodiment, the source may include one or more endpoint devices (e.g., endpoint devices 102) and the destination may include one or more DMZs (e.g., DMZs 110). In another embodiment, the source may include one or more cloud service providers (e.g., cloud service providers 120) and the destination may include one or more DMZs (e.g., DMZs 110). At operation 204, the processor 160 obtains metadata from the collected network traffic data. In some embodiments, operations 202 and 204 are performed by the data collector 132 or 134, each of which is implemented by the processor 160.

At operation 206, the processor 160 parses the network traffic data and/or obtained metadata to identify a plurality of parameters associated with the network traffic data at different network layers. At operation 208, the processor 160 stores parsed network traffic data and identified parameters associated with the network traffic data in a first data store (e.g., first data store 152 of memory 150). In some embodiments, operations 206 and 208 are performed by the data typification component 136 that is implemented by the processor 160.

At operation 210, the processor 160 retrieves the parsed network traffic data and the identified parameters associated with the network traffic data at the different network layers from the first data store (e.g., first data store 152 of memory 150). At operation 212, the processor 160 extracts a subset of network traffic data from the collected network traffic data using retrieved data from the first data store (e.g., first data store 152 of memory 150). The extracted subset of network traffic data may be associated with one or more specific parameters of the plurality of parameters at one or more network layers. The extracted subset of network traffic data may be used to identify one or more anomalous network sessions. In some embodiments, operations 210 and 212 are performed by the data extraction component 138 that is implemented by the processor 160.

Now referring to FIG. 2B, at operation 214, the processor 160 clusters network traffic data into baseline network traffic data based on one or more specific parameters of the plurality of parameters associated with the network traffic data at one or more network layers. In one embodiment, clustering is performed based on the extracted subset of network traffic data. At operation 215, the processor 160 identifies unknown network traffic (e.g., one or more outliers) based at least in part upon the clustered network traffic data. At operation 216, the processor 160 stores the clustered network traffic data, including the baseline network traffic data and the unknown network traffic, in a second data store (e.g., second data store 154 of memory 150). In some embodiments, operations 214-216 are performed by the hierarchical clustering component 140 that is implemented by the processor 160.

At operation 218, the processor 160 retrieves clustered network traffic data, including baseline network traffic data and unknown network traffic, from the second data store (e.g., second data store 154 of memory 150). The processor 160 performs cluster analysis discussed herein using the clustered network traffic data retrieved from the second data store (e.g., second data store 154 of memory 150). In one embodiment, the cluster analysis may include analyzing the unknown network traffic with respect to the baseline network traffic data to determine whether or not the unknown network traffic is anomalous and identifying the one or more anomalous network sessions in the plurality of network sessions.

At operation 220, the processor 160 analyzes unknown network traffic with respect to the baseline network traffic data to identify one or more anomalous network sessions in the plurality of network sessions. At operation 222, the processor 160 determines whether one or more anomalous network sessions are identified based on the cluster analysis. If there are no anomalous network sessions identified, method 200 proceeds to operation 224, where the processor 160 determines the plurality of network sessions as legitimate network sessions. If one or more anomalous network sessions are identified, method 200 proceeds to operation 226 of FIG. 2C to perform prohibition analysis associated with the prohibition analysis component 144 discussed herein. In some embodiments, operations 218-224 are performed by the cluster analysis component 142 that is implemented by the processor 160.

Now referring to FIG. 2C, at operation 226, the processor 160 determines one or more mitigation actions for the identified one or more anomalous network sessions. Next, method 200 proceeds to operation 228, where the processor 160 determines whether to terminate the identified one or more anomalous network sessions. If the result of the determination of operation 228 is positive, method 200 proceeds to operation 230, where the processor 160 terminates the identified one or more anomalous network sessions. After operation 230, method 200 ends.

If the result of the determination of operation 228 is negative, method 200 proceeds to operation 232, where the processor 160 determines whether to slow down network traffic. If the result of the determination of operation 232 is positive, method 200 proceeds to operation 234, where the processor 160 slows down network traffic across the identified one or more anomalous network sessions. After operation 234, method 200 ends.

If the result of the determination of operation 232 is negative, method 200 proceeds to operation 236, where the processor 160 determines whether to re-route identified one or more anomalous network sessions. If the result of determination of operation 236 is positive, method 200 proceeds to operation 238, where the processor 160 re-routes the identified one or more anomalous network sessions to a particular location (e.g., a honeypot). After operation 238, method 200 ends.

If the result of the determination of operation 236 is negative, method 200 proceeds to operation 240, where the processor 160 determines whether to re-authenticate users. If the result of the determination of operation 240 is positive, method 200 proceeds to operation 242, where the processor 160 requests users associated with the identified one or more anomalous network sessions to re-authenticate. After operation 242, method 200 ends.

If the result of the determination of operation 240 is negative, method 200 proceeds to operation 244, where the processor 160 determines whether to disapprove identified one or more anomalous network sessions. If the result of determination of operation 244 is negative, method 200 proceeds back to operation 226 to again determine one or more mitigation actions for the identified one or more anomalous network sessions. If the result of the determination of operation 244 is positive, the method 200 proceeds to operation 246, where the processor 160 adds network characteristics and users associated with the identified one or more anomalous network sessions to a disapproved list. After operation 246, method 200 ends. In some embodiments, operations 226-246 are performed by prohibition analysis component 144 that is implemented by processor 160. The prohibition analysis component 144 may perform the one or more mitigation actions discussed herein for the identified one or more anomalous network sessions without disrupting other network sessions in the plurality of network sessions.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system for identifying one or more anomalous network sessions in a network environment comprising:
a memory comprising a first data store and a second data store, wherein the first data store is operable to store network traffic data, and wherein the second data store is operable to store clustered network traffic data; and
a processor, operably coupled with the memory, and configured to:
collect the network traffic data based at least in part on a plurality of network sessions between a source and a destination in the network environment;
parse the network traffic data to identify a plurality of parameters associated with the network traffic data at different network layers;
cluster the network traffic data into baseline network traffic data based on one or more specific parameters of the plurality of parameters associated with the network traffic data at one or more network layers;
identify unknown network traffic based at least in part upon the clustered network traffic data;
analyze the unknown network traffic with respect to the baseline network traffic data to identify the one or more anomalous network sessions in the plurality of network sessions;
determine one or more mitigation actions for the identified one or more anomalous network sessions; and
perform the one or more mitigation actions for the identified one or more anomalous network sessions, wherein the one or more mitigation actions are performed for the identified one or more anomalous network sessions without disrupting other network sessions in the plurality of network sessions.

2. The system of claim 1, wherein the processor is further configured to:
obtain metadata from the collected network traffic data;
wherein the parsing, the clustering, and the analyzing the unknown network traffic are performed based at least in part upon the metadata obtained from the collected network data.

3. The system of claim 1, wherein the processor is further configured to:
store the parsed network traffic data and identified parameters associated with the network traffic data in the first data store;
retrieve the parsed network traffic data and the identified parameters associated with the network traffic data at the different network layers from the first data store; and
extract a subset of network traffic data from the collected network traffic data using the retrieved data from the first data store, wherein:
the extracted subset of network traffic data is associated with the one or more specific parameters of the plurality of parameters at the one or more network layers;
the extracted subset of network traffic data is used to identify the one or more anomalous network sessions; and
the clustering is performed based on the extracted subset of network traffic data.

4. The system of claim 3, wherein the clustering the network traffic data comprises:
comparing the subset of network traffic data against one or more predetermined thresholds; and
generating a cluster of the baseline network traffic data and the unknown network traffic based on the comparison.

5. The system of claim 1, wherein the one or more mitigation actions for the identified one or more anomalous network sessions comprise:
terminating the one or more anomalous network sessions;
slowing down network traffic across the one or more anomalous network sessions;
re-routing the one or more anomalous network sessions to a particular location;
restarting one or more network sessions affected by the one or more anomalous network sessions;
requesting users associated with the one or more anomalous network sessions to re-authenticate;
locking user accounts of the users associated with the one or more anomalous network sessions; or
adding network characteristics and the users associated with the one or more anomalous network sessions to a disapproved list.

6. The system of claim 1, wherein one or more of the parsing, the clustering, or the analyzing the unknown network traffic is performed using machine learning or artificial intelligence techniques.

7. The system of claim 1, wherein the clustering is performed using one or more of:
K-means clustering; or
Calinski-Harabasz criterion clustering.

8. The system of claim 1, wherein the processor is further configured to:
store the clustered network traffic data in the second data store;
retrieve the clustered network traffic data from the second data store; and
perform cluster analysis using the clustered network traffic data retrieved from the second data store;
wherein the cluster analysis comprises analyzing the unknown network traffic with respect to the baseline network traffic data to determine whether or not the unknown network traffic is anomalous and identifying the one or more anomalous network sessions in the plurality of network sessions responsive to determining that the unknown network traffic is anomalous.

9. The system of claim 1, wherein:
the source comprises one or more endpoint devices; and
the destination comprises one or more network demilitarized zones (DMZs).

10. The system of claim 1, wherein:
the source comprises one or more cloud service providers; and
the destination comprises one or more network demilitarized zones (DMZs).

11. A method for identifying one or more anomalous network sessions in a network environment comprising:
collecting network traffic data based at least in part on a plurality of network sessions between a source and a destination in the network environment;
parsing the network traffic data to identify a plurality of parameters associated with the network traffic data at different network layers;
clustering the network traffic data into baseline network traffic data based on one or more specific parameters of the plurality of parameters associated with the network traffic data at one or more network layers;
identifying unknown network traffic based at least in part upon the clustered network traffic data;
analyzing the unknown network traffic with respect to the baseline network traffic data to identify the one or more anomalous network sessions in the plurality of network sessions;
determining one or more mitigation actions for the identified one or more anomalous network sessions; and
performing the one or more mitigation actions for the identified one or more anomalous network sessions, wherein the one or more mitigation actions are performed for the identified one or more anomalous network sessions without disrupting other network sessions in the plurality of network sessions.

12. The method of claim 11, further comprising:
obtaining metadata from the collected network traffic data;
wherein the parsing, the clustering, and the analyzing the unknown network traffic are performed based at least in part upon the metadata obtained from the collected network data.

13. The method of claim 11, further comprising:
storing the parsed network traffic data and identified parameters associated with the network traffic data in a first data store;
retrieving the parsed network traffic data and the identified parameters associated with the network traffic data at the different network layers from the first data store; and
extracting a subset of network traffic data from the collected network traffic data using the retrieved data from the first data store, wherein:
the extracted subset of network traffic data is associated with the one or more specific parameters of the plurality of parameters at the one or more network layers;
the extracted subset of network traffic data is used to identify the one or more anomalous network sessions; and
the clustering is performed based on the extracted subset of network traffic data.

14. The method of claim 13, wherein the clustering the network traffic data comprises:
comparing the subset of network traffic data against one or more predetermined thresholds; and
generating a cluster of the baseline network traffic data and the unknown network traffic based on the comparison.

15. The method of claim 11, wherein the one or more mitigation actions for the identified one or more anomalous network sessions comprise:
terminating the one or more anomalous network sessions;
slowing down network traffic across the one or more anomalous network sessions;
re-routing the one or more anomalous network sessions to a particular location;
restarting one or more network sessions affected by the one or more anomalous network sessions;
requesting users associated with the one or more anomalous network sessions to re-authenticate;
locking user accounts of the users associated with the one or more anomalous network sessions; or
adding network characteristics and the users associated with the one or more anomalous network sessions to a disapproved list.

16. A non-transitory computer-readable medium storing instructions that when executed by a processor cause the processor to:
collect network traffic data based at least in part on a plurality of network sessions between a source and a destination in a network environment;
parse the network traffic data to identify a plurality of parameters associated with the network traffic data at different network layers;
cluster the network traffic data into baseline network traffic data based on one or more specific parameters of the plurality of parameters associated with the network traffic data at one or more network layers;
identify unknown network traffic based at least in part upon the clustered network traffic data;
analyze the unknown network traffic with respect to the baseline network traffic data to identify one or more anomalous network sessions in the plurality of network sessions;
determine one or more mitigation actions for the identified one or more anomalous network sessions; and
perform the one or more mitigation actions for the identified one or more anomalous network sessions, wherein the one or more mitigation actions are performed for the identified one or more anomalous network sessions without disrupting other network sessions in the plurality of network sessions.

17. The non-transitory computer-readable medium of claim 16, wherein the instructions further cause the processor to:
obtain metadata from the collected network traffic data;
wherein the parsing, the clustering, and the analyzing the unknown network traffic are performed based at least in part upon the metadata obtained from the collected network data.

18. The non-transitory computer-readable medium of claim 16, wherein the instructions further cause the processor to:
store the parsed network traffic data and identified parameters associated with the network traffic data in a first data store;
retrieve the parsed network traffic data and the identified parameters associated with the network traffic data at the different network layers from the first data store; and
extract a subset of network traffic data from the collected network traffic data using retrieved data from the first data store, wherein:
the extracted subset of network traffic data is associated with the one or more specific parameters of the plurality of parameters at the one or more network layers;
the extracted subset of network traffic data is used to identify the one or more anomalous network sessions; and
the clustering is performed based on the extracted subset of network traffic data.

19. The non-transitory computer-readable medium of claim 18, wherein the clustering the network traffic data comprises:
comparing the subset of network traffic data against one or more predetermined thresholds; and
generating a cluster of the baseline network traffic data and the unknown network traffic based on the comparison.

20. The non-transitory computer-readable medium of claim 16, wherein the one or more mitigation actions for the identified one or more anomalous network sessions comprise:
terminating the one or more anomalous network sessions;
slowing down network traffic across the one or more anomalous network sessions;
re-routing the one or more anomalous network sessions to a particular location;
restarting one or more network sessions affected by the one or more anomalous network sessions;
requesting users associated with the one or more anomalous network sessions to re-authenticate;
locking user accounts of the users associated with the one or more anomalous network sessions; or
adding network characteristics and the users associated with the one or more anomalous network sessions to a disapproved list.
